(19) United States
(12) Patent Application Publication
(10) Pub. No.: US 2011/0233225 A1
(43) Pub. Date: Sep. 29, 2011

(54) FUEL TANK STRUCTURE OF VEHICLE

(75) Inventor: Shinji GOTO, Hiroshima (JP)

(73) Assignee: MAZDA MOTOR CORPORATION, Hiroshima (JP)

(21) Appl. No.: 13/013,524

(22) Filed: Jan. 25, 2011

(30) Foreign Application Priority Data
Mar. 25, 2010 (JP) 2010-070069

(51) Int. Cl. B60K 15/035

(52) U.S. Cl. 220/746

(57) ABSTRACT

Inside a fuel tank body which is installed at a vehicle and in an inside space of which an air inlet of a breather pipe is arranged a fuel-level rise delaying device to delay a rise in a level of fuel supplied in the fuel tank body in a specified range around the air inlet of the breather pipe from a fuel-level rise in the other range. Accordingly, a fuel tank structure of a vehicle which can increase a tank volume with a proper outer shape of the tank is provided.

### BACKGROUND OF THE INVENTION

The present invention relates to a fuel tank structure of a vehicle using liquid fuel.

In vehicles, such as a four-wheel drive type of vehicle, or an FR (front engine/rear drive) type of vehicle, a propeller shaft to transmit a drive power to rear wheels is arranged in a vehicle longitudinal direction below a floor panel. Further, in any vehicle equipped with an engine at a vehicle's front portion, an exhaust pipe to exhaust engine's exhaust gas rearwardly is arranged in the vehicle longitudinal direction below the floor panel.

Thus, in many four-wheel drive or FR types of vehicles, a saddle type of fuel tank shown in FIG. 9 is applied, for example, in order to avoid any interference of the fuel tank arranged below the floor panel at a vehicle rear portion with the propeller shaft or the exhaust pipe.

That is, as shown in FIG. 9, a saddle type of fuel tank 110 has an upwardly-concaved portion 116 extending in the vehicle longitudinal direction at a central portion of its lower face. A propeller shaft 106 and an exhaust pipe 108 are arranged to pass through in this upwardly-concaved portion 116, avoiding any interference between the fuel tank 110 and the propeller shaft 106 or the exhaust pipe 108.

In this saddle type of fuel tank 110, a saddle portion 118 which projects upwardly is formed at a central portion of a bottom face of the tank. Thus, the inside of the saddle type of fuel tank 110 is separated into left and right inside spaces 122, 124.

Meanwhile, a breather pipe 140 which exhausts air inside the tank, not limiting to the saddle type of fuel tank, while the fuel is supplied into the fuel tank is generally applied to the fuel tank 110. Herein, in general, an air inlet of the breather pipe 140 is arranged in an inside space of the fuel tank, and an air outlet of the breather pipe 140 is coupled to an upstream end portion of a fuel supply pipe. In case the level of the fuel in the tank rises during the fuel supply, the air above the fuel level is pushed out through the breather pipe 140, so that the fuel supply may not be hindered. Once the fuel level rises up to the air inlet 148 of the breather pipe 140, the above-described tank-inside-air exhaustion through the breather pipe is not allowed any more. Consequently, any further increase of the fuel level is restrained, so that the fuel supply is stopped.

A structure of the above-described saddle type of fuel tank is disclosed in Japanese Patent Laid-Open Publication No. 2004-189074, for example. In this structure, a baffle plate is provided so as to enclose a cut valve arranged at the saddle portion so that the fuel moving between both side fuel spaces in the tank can flow over the saddle portion, avoiding the above-described cut valve.

However, since the upwardly-concaved portion is formed at the central portion of the lower face of the saddle type of fuel tank, the volume of this tank may be smaller than that of the normal (non-saddle type) tank. Further, it may not be easy to enlarge an outer shape of the fuel tank from some restrictions in the layout of surrounding members. Therefore, it has been desired that the tank volume of the saddle type of fuel tank, in particular, is increased with the proper outer shape of the tank.

Herein, it may be considered that the fuel level for stopping the fuel supply can be higher by locating the air inlet of the breather pipe at a higher position in order to increase the tank volume. However, the position of the air inlet of the breather pipe may not be necessarily arranged at an uppermost location in the fuel tank from the layout restrictions. Further, in case the air inlet of the breather pipe is located at a lower position, the fuel supply may be stopped in a state in which a rather large space remains above the fuel level in the tank, so that the tank volume may not be used sufficiently. This problem may happen to the non-saddle type of fuel tank as well.

### SUMMARY OF THE INVENTION

An object of the present invention is to provide a fuel tank structure of a vehicle which can increase the tank volume with the proper outer shape of the tank.

According to the present invention, there is provided a fuel tank structure of a vehicle, comprising a fuel tank body installed at the vehicle, a fuel supply pipe supplying fuel into the fuel tank body, a breather pipe connecting an inside and an outside of the fuel tank body, an air inlet of the breather pipe being arranged in an inside space of the fuel tank body, and a fuel-level rise delaying device provided inside the fuel tank body to delay a rise in a level of the fuel supplied via the fuel supply pipe in a specified range around the air inlet of the breather pipe from a fuel-level rise in the other range.

According to the present invention, since the rise in the fuel level in the fuel tank body during the fuel supply is delayed in the specified range around the air inlet of the breather pipe from the fuel-level rise in the other range, more fuel can be supplied into the fuel tank body before the air inlet is under the fuel level and thereby the fuel supply is stopped. Accordingly, the tank volume can be increased with the proper outer shape of the tank.

According to an embodiment of the present invention, the fuel tank body has an upwardly-concaved portion extending in a vehicle longitudinal direction at a lower face thereof, the fuel tank body comprises a main tank portion and a sub tank portion which are separated from each other by the upwardly-concaved portion of the fuel tank body, the fuel supply pipe is connected to an inside space of the main tank portion, the air inlet of the breather pipe is arranged in an inside space of the sub tank portion, and the fuel-level rise delaying device comprises a partitioning member which is arranged to stand at the upwardly-concaved portion of the fuel tank body and partition the inside space of the sub tank portion from the inside space of the main tank portion, an upper end of the partitioning member standing at the upwardly-concaved portion being located at a specified height position which is higher than the air inlet of the breather pipe. Thereby, since the fuel move from the main tank portion to the sub tank portion during the fuel supply is restricted by the partitioning member standing at the saddle portion (i.e., the upwardly-concaved portion) of the fuel tank body, the rise in the fuel level in the sub tank portion can be delayed. Accordingly, more fuel can be supplied into the main tank portion of the fuel tank body with a simple structure before the air inlet arranged in the inside space of the sub tank portion is under the fuel level. Thus, the tank volume can be increased.

According to another embodiment of the present invention, the breather pipe is provided to extend from the outside of the fuel tank body to the inside of the fuel tank body, passing through a breather-pipe insertion portion formed at a wall portion of the main tank portion, and the breather pipe comprises a tank-outside pipe portion which is positioned outside the fuel tank body so as to extend outside from the breather-pipe insertion portion of the fuel tank body and a tank-inside pipe portion which is positioned inside the fuel tank body so as to extend from the breather-pipe insertion portion to the air inlet. Thereby, since the breather pipe extends inside the fuel tank body over a specified range from the breather-pipe insertion portion formed at the main tank portion to the air inlet arranged in the sub tank portion, the length of the tank-outside pipe portion of the breather pipe can be shorter. Accordingly, the restrictions in the space around the fuel tank body can be decreased.

According to another embodiment of the present invention, the fuel-level rise delaying device comprises an enclosing member which has an opening for ventilation at a specified height position which is higher than the air inlet of the breather pipe and encloses the air inlet of the breather pipe at least from below and side. Thereby, since the rise in the fuel level inside the enclosing member during the fuel supply is delayed from the rise in the fuel level outside the enclosing member, more fuel can be supplied into the fuel tank body before the air inlet arranged inside the enclosing member is under the fuel level and thereby the fuel supply is stopped. Thus, the tank volume can be increased with the simple structure.

According to another embodiment of the present invention, the enclosing member has a passing adjusting device at a lower end portion thereof, the passing adjusting device allowing the fuel to flow out from an inside space to an outside space of the enclosing member, restricting the fuel flowing into the inside space from the outside space of the enclosing member. Thereby, when the fuel level is positioned below the passing adjusting device formed at the lower end portion of the enclosing member, the fuel coming into the inside of the enclosing member can be discharged through the passing adjusting device. Meanwhile, when the fuel level outside the enclosing member rises up to the passing adjusting device during the fuel supply, the fuel flowing into the inside space from the outside space of the enclosing member is restricted by the passing adjusting device, so that the rise in the fuel level inside the enclosing member can be delayed securely.

According to another embodiment of the present invention, the passing adjusting device comprises a through hole which is formed at the lower end portion of the enclosing member. Thereby, the passing adjusting device can be configured simply by forming the through hole at the lower end portion of the enclosing member.

According to another embodiment of the present invention, the fuel tank body has an upwardly-concaved portion extending in a vehicle longitudinal direction at a lower face thereof, the fuel tank body comprises a main tank portion and a sub tank portion which are separated from each other by the upwardly-concaved portion of the fuel tank body, the fuel supply pipe is connected to an inside space of the main tank portion, and the air inlet of the breather pipe and the enclosing member are arranged in an inside space of the sub tank portion. Thereby, since the air inlet of the breather pipe and the enclosing member are arranged inside the sub tank portion where the fuel surface is relatively stable compared to that in the main tank portion, the fuel flowing into the inside space from the outside space of the enclosing member can be restricted more securely. Thus, the tank volume can be increased effectively.

Herein, the air inlet of the breather pipe and the enclosing member may be alternatively arranged in an inside space of the main tank portion instated of the inside space of the sub tank portion.

Other features, aspects, and advantages of the present invention will become apparent from the following description which refers to the accompanying drawings.

### BRIEF DESCRIPTION OF THE DRAWINGS

FIG. 1 is a back view of a fuel tank body according to a first embodiment.

FIG. 2 is a sectional view taken along line A-A of FIG. 1.

FIG. 3 is a sectional view taken along line B-B of FIG. 2.

FIG. 4 is a perspective view of a lower hosing of the fuel tank body shown in FIG. 1.

FIGS. 5A and 5B show states of a fuel level in the fuel tank body during a fuel supply and after a stop of the fuel supply, respectively.

FIG. 6 is a plan sectional view showing a fuel tank structure according to a second embodiment.

FIG. 7 is a sectional view taken along line C-C of FIG. 6.

FIG. 8 is a plan sectional view showing a fuel tank structure according to a third embodiment.

FIG. 9 is an elevation sectional view showing an example of a conventional fuel tank structure.

### DETAILED DESCRIPTION OF THE INVENTION

Hereinafter, preferred embodiments of the present invention will be described referring to the accompanying drawings.

### Embodiment 1

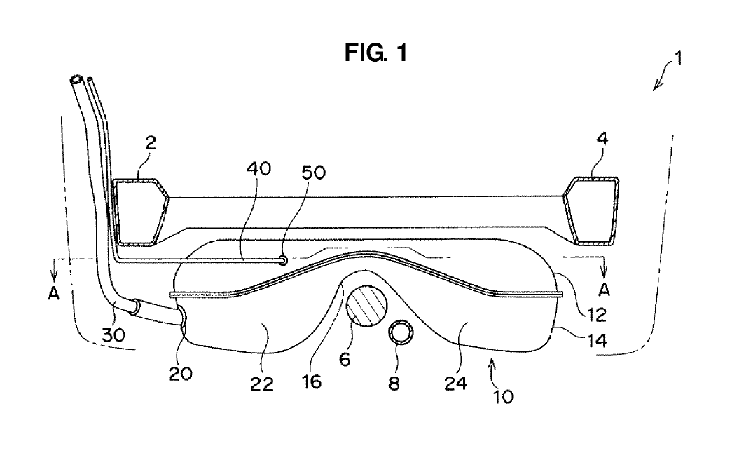

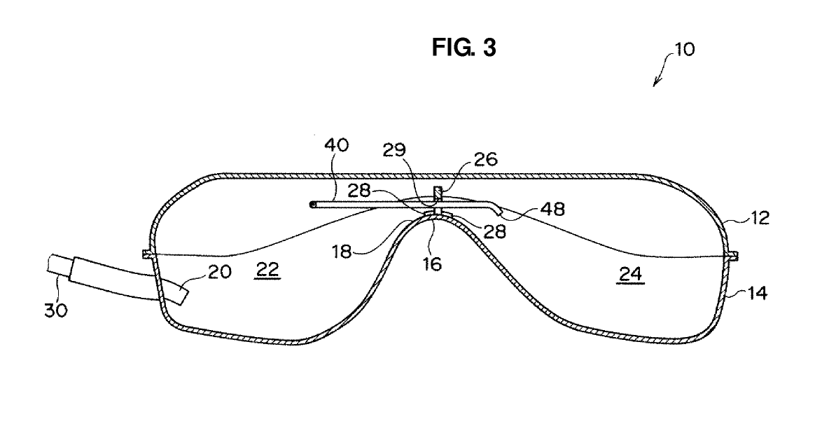

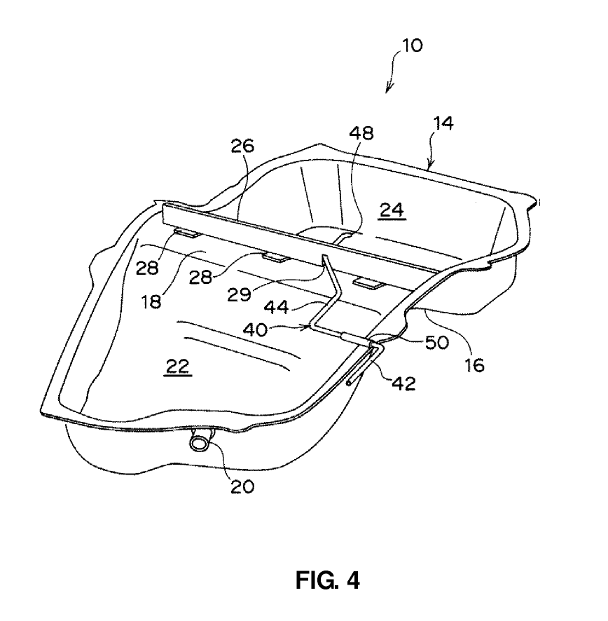

A fuel tank structure of a vehicle according to a first embodiment will be described referring to FIGS. 1 through 5A, B.

FIG. 1 is a back view of a fuel tank body 10 which is installed at a four-wheel drive type of vehicle 1, for example. A pair of side frames 2, 4 is provided at both-side end portions of the vehicle 1 and extends in a vehicle longitudinal direction. At a central portion, in a vehicle width direction, of the vehicle 1 are provided a propeller shaft 6 to transmit a drive power to rear wheels and an exhaust pipe 8 to exhaust exhaust gas of an engine rearwardly. These members 6, 8 extend in the vehicle longitudinal direction.

The fuel tank body 10 comprises an upper housing 12 and a lower housing 14 which are joined together, and is installed at a rear portion of the vehicle 1. This fuel tank body 10 is a so-called saddle type of fuel tank and has an upwardly-concaved portion 16 extending in the vehicle longitudinal direction at a central portion of its lower face. The above-described propeller shaft 6 and exhaust pipe 8 extend in the upwardly-concaved portion 16, so that any interference of the fuel tank body 10 with the propeller shaft 6 and the exhaust pipe 8 can be avoided.

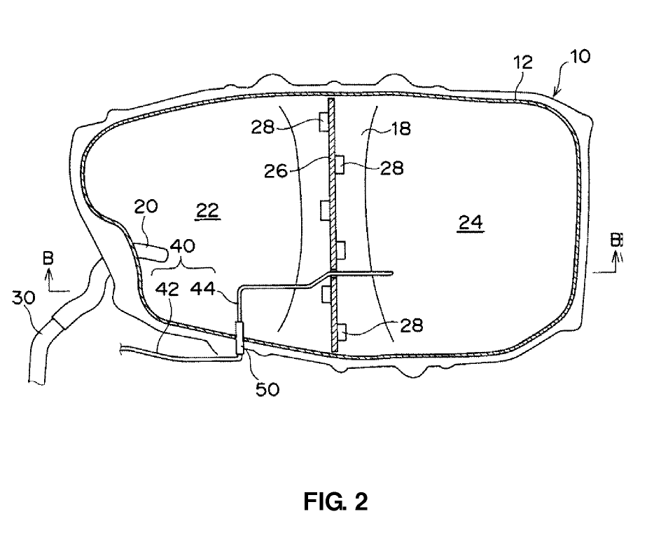

As shown in FIGS. 2 through 4, a saddle portion 18 projecting upwardly is formed at a specified position of a bottom face of the fuel tank body 10 which corresponds to the upwardly-concaved portion 16. Thus, the fuel tank body 10 comprises a main tank portion 22 and a sub tank portion 24 which are separated from each other by the upwardly-concaved portion 16 of the fuel tank body 10.

The main tank portion 22 has a fuel-supply-pipe connection portion 20 at the lower housing 14, for example. A downstream end portion of the fuel supply pipe 30 to supply the liquid fuel into the fuel tank body is coupled to the fuel-supply-pipe connection portion 20. Herein, an upstream end portion of the fuel supply pipe 30 is coupled to a fuel supply port, not illustrated, which is provided at a specified position of a vehicle-side face which is located closer to the main tank portion 22 than the sub tank portion 24.

Since the fuel supply pipe 30 is connected to the main tank portion 22, the fuel to be supplied into the fuel tank body 10 fills up the main tank portion 22 first, and then the fuel which has overflowed from the main tank portion 22 flows over the saddle portion 18 and then into the sub tank portion 24.

Further, a cylindrical breather-pipe insertion portion 50 is provided at the upper housing 12, for example, of the main tank portion 22, and a breather pipe 40 is inserted into this breather-pipe insertion portion 50.

An air inlet 48 of the breather pipe 40 is arranged in an inside space of the sub tank portion 24, and an air outlet, not illustrated, of the breather pipe 40 is connected to the fuel supply pipe 30 at a specified position near the above-described fuel supply port.

The breather pipe 40 comprises a tank-outside pipe portion 42 which is positioned outside the fuel tank body 10 so as to extend from the above-described fuel supply portion to the breather-pipe insertion portion 50 and a tank-inside pipe portion 44 which is positioned inside the fuel tank body 10 so as to extend from the breather-pipe insertion portion 50 to the air inlet 48. The tank-inside pipe portion 44 extends and bends in a specified horizontal face in the inside space of the main tank portion 22. By arranging so that the breather pipe 40 has the tank-inside pipe portion 44, a properly smaller part of pipe portion can be located outside the fuel tank body 10, so that restrictions in the space around the fuel tank body 10 can be decreased.

The breather pipe 40 performs the function of releasing the air in the tank body 10 in order not to hinder the smooth fuel supply. Specifically speaking, when the fuel level in the fuel tank body 10 rises through the fuel supplying, the air in the space of the tank body 10 above the fuel level is pushed out toward the outside of the tank body 10 through the breather pipe 40. Thereby, as long as the air inlet 48 of the breather pipe 40 is not closed, the rise in the fuel level in the tank body 10, that is, the fuel supply is not prevented. Then, once the fuel level rises up to the air inlet 48 of the breather pipe 40 during the fuel supply, the air in the tank body 10 is prevented from being released (exhausted) through the breather pipe 40. As a result, the further rise in the fuel level is prevented, so that the fuel supply is stopped.

The breather pipe 40 is arranged as a whole at a height position which is higher than the air inlet 48 in order to release the air in the tank body 10 upwardly during the fuel supply (see FIG. 1). The tank-outside pipe portion 42 of the breather pipe 40 is arranged to extend below the side frame 2 in order to avoid its interference with the side frame 2. The air inlet 48 of the breather pipe 40 is arranged at a specified position which is lower than the side frame 2, consequently, which is lower than an uppermost portion in the fuel tank body 10 by a certain degree. Thus, while some space remains between the fuel level and the ceiling face in the tank body 10 even in case the tank is filled up with the fuel, the present invention utilizes the remaining space so that the tank volume can be increased as described below.

In the present embodiment, a partitioning member 26 is arranged inside the fuel tank body 10 as a fuel-level rise delaying device to delay a rise in the fuel level in a specified range around the air inlet 48 of the breather pipe 40 from a fuel-level rise in the other range.

This partitioning member 26 is arranged to stand at the top of the saddle portion 18 (i.e., the upwardly-concaved portion 16) of the fuel tank body 10 and partition the inside space of the sub tank portion 24 from the inside space of the main tank portion 22, an upper end of the partitioning member 26 being located at a specified height position which is higher than the air inlet 48 of the breather pipe 40. Herein, the above-described partitioning member 26 may not necessarily partition perfectly the inside space of the sub tank portion 24 from the inside space of the main tank portion 22, so that some gap may be formed between the partitioning member 26 and the wall face of the fuel tank body 10.

The partitioning member 26 is made of a metal-made band-plate shaped member, for example, and extends in the vehicle longitudinal direction. Plural fixing pieces 28 are provided at a lower end of the partitioning member 26 in the vehicle longitudinal direction. These fixing pieces 28 are fixed to the surface of the saddle portion 18 by welding, for example.

Further, the partitioning member 26 has a slit 29 which extends vertically, through which the breather pipe 40 extends. While the slit 29 is formed to open downwardly in the present embodiment, it may be formed to open upwardly. Further, a hole may be applied in place of the slit 29.

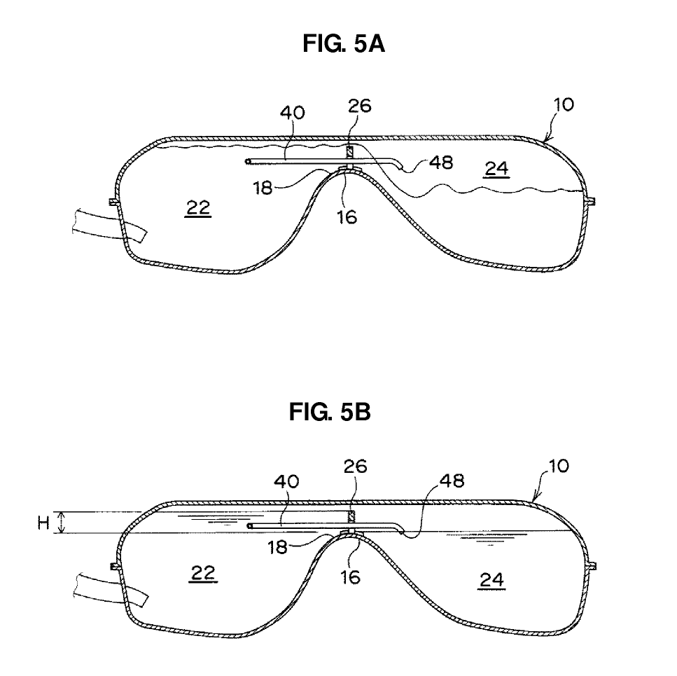

Herein, even if the fuel level inside the main tank portion 22 rises up above the height of the saddle portion 18 through the fuel supply as shown in FIG. 5A, the move of the fuel from the main tank portion 22 to the sub tank portion 24 is restricted by the partitioning member 26. Further, the fuel inside the main tank portion 22 is dammed up by the partitioning member 26 to some degree. Therefore, the fuel level of main tank portion 22 rises continuously up to the height position of the partitioning member 26. Thus, until the fuel level of the main tank portion 22 rises over the saddle portion 18 and then up to the height position of the partitioning member 26, only part of the fuel which passes through the gap between the partitioning member 26 and wall face of the tank body 10, passes through the slit 29 of the partitioning member 26, or flows over the partitioning member 26 due to a swing of the fuel level in the main tank portion 22 move into the sub tank portion 24. Accordingly, the rise in the fuel level of the sub tank portion 24 is not started substantially.

Then, after the fuel level of the main tank portion 22 rises up to the height position of the partitioning member 26, no more rise in the fuel level inside the main tank portion occurs, so that substantially the same amount of fuel as the supply amount of fuel from the fuel supply pipe 30 to the main tank portion 22 flows over from the main tank portion 22 to the sub tank portion 24. Accordingly, the rise in the fuel level inside the sub tank portion 24 is started substantially.

As described, the rise in the fuel level of the sub tank portion 24 is delayed by the partitioning member 26, and thereby the stop of the fuel supply which may be caused by the fuel level reaching and closing the air inlet 48 of the breather pipe 40 is also delayed.

Right after the air inlet 48 of the breather pipe 40 is closed by the fuel, i.e., the fuel supply is stopped, a state shown in FIG. 5B occurs. In this state, the fuel level of the main tank portion 22 is substantially the same as the height position of the partitioning member 26, and becomes higher by a specified height H, compared to the height of the case in which the partitioning member 26 is not provided (see FIG. 9), that is, the low-limit height of the fuel level for closing the air inlet 48 of the breather pipe 40. Accordingly, more fuel can be supplied into the fuel tank body 10. Thus, according to the present embodiment, the tank volume (the amount of fuel supply) can be increased without changing the outer shape of the tank body 10, i.e., with the proper outer shape of the tank body 10.

### Embodiment 2

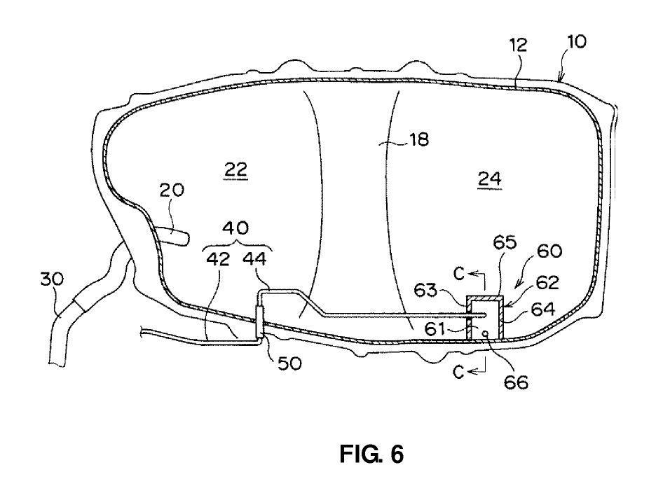

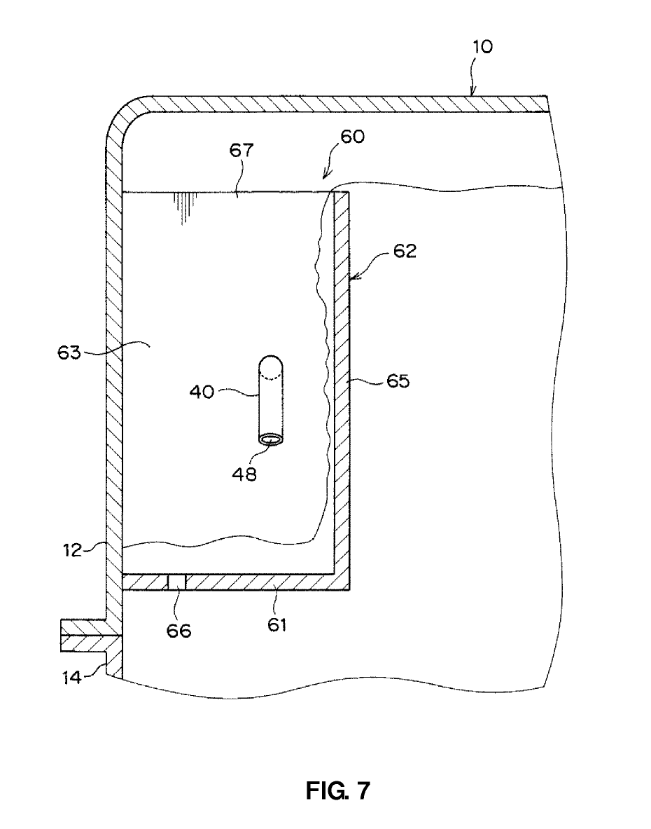

A fuel tank structure of a vehicle according to a second embodiment will be described referring to FIGS. 6 and 7.

In the second embodiment, an enclosing member 60 which encloses the air inlet 48 of the breather pipe 40 at least from below and side is used as the fuel-level rise delaying device in place of the partitioning member 26 of the first embodiment.

The air inlet 48 of the breather pipe 40 is arranged in the inside space of the sub tank portion 24 in the present embodiment as well, and the enclosing member 60 is also arranged in the inside space of the sub tank portion 24.

The enclosing member 60 comprises a bottom face portion 61 which is provided below the air inlet 48 and a peripheral wall portion 62 which stands from the bottom face portion 61 and encloses the side of the air inlet 48. The enclosing member 60 is made of metal, for example, but its material is not limited to metal.

While the bottom face portion 61 is arranged substantially horizontally, it may be provided to slant relative to the horizontal direction.

A through hole 66 is formed at the bottom face portion 61 as a passing adjusting device which allows the fuel to flow out from the inside space to the outside space of the enclosing member 60, restricting the fuel flowing into the inside space from the outside space of the enclosing member 60. Accordingly, in case the fuel level outside the enclosing member 60 is lower than the height position of the through hole 66, the fuel coming into the inside of the enclosing member 60 can be discharged through the through hole 66.

Further, the through hole 66 is configured to restrict the fuel flowing into the inside space from the outside space of the enclosing member 60 so that the rise in the fuel level inside the enclosing member 60 can be delayed when the fuel level in the fuel tank body 10 rises up to the through hole 66 during the fuel supply.

The specific structures, such as a size or shape of the above-described through hole, the roughness of the peripheral wall, should not be limited in particular.

The peripheral wall portion 62 comprises a left-side wall portion 63 which is arranged on the left of the air inlet 48, a right-side wall portion 64 which is arranged on the right of the air inlet 48, facing to the left-side wall portion 63, and a front-side wall portion 65 which is arranged in front of the air inlet 48, connecting a front end portion of the left-side wall portion 63 and a front end portion of the right-side wall portion 64. These wall portions 63, 64, 65 are formed so that their upper ends are located above the air inlet 48. Respective rear end portions of the left-side and right-side wall portions 63, 64 are fixed to the wall face of the fuel tank body 10 by welding, for example, whereby the peripheral wall portion 62 encloses the side of the air inlet 48 of the breather pipe 40 together with the wall face of the tank body 10.

Herein, the peripheral wall portion 62 may be formed in a cylindrical shape so that the side of the air inlet 48 can be enclosed only by this peripheral wall portion 62.

An upper-end opening portion of the enclosing member 60 constitutes an opening for ventilation 67, through which the inside space and the outside space of the enclosing member 60 are connected to each other. Accordingly, when the fuel level outside the enclosing member 60 rises through the fuel supply, the air above the fuel level is pushed, through the opening for ventilation 67, into the inside of the enclosing member 60, and guided to the air inlet 48 finally.

Further, since the opening for ventilation 67 is arranged at a specified height position which is higher than the air inlet 48, even if the fuel level outside the enclosing member 60 rises up to the height of the air inlet 48 through the fuel supply, the fuel can be restrained from flowing into the inside of the enclosing member 60 through the opening for ventilation 67. Further, since the air inlet 48 and the enclosing member 60 are arranged in the inside space of the sub tank portion 24 which has a relatively stable fuel surface compared to the main tank portion 22, the fuel flowing over the peripheral wall portion 62 and into the inside space of the enclosing member 60 can be restricted more securely. Thereby, the rise in the fuel level inside the enclosing member 60, i.e., the fuel level around the air inlet 48, can be delayed compared to that of the fuel level outside the enclosing member 60. Thus, stopping the fuel supply by the fuel closing the air inlet 48 can be properly delayed.

When the fuel level outside the enclosing member 60 rises up further and has reached the height position of the opening for ventilation 67, the fuel flows into the inside of the enclosing member 60 from the outside of the enclosing member 60 through the opening for ventilation 67, so that the rise in the fuel level inside the enclosing member 60 is started substantially. Then, after the fuel level inside the enclosing member 60 rises up to the height position of the air inlet 48, further rise in the fuel level is restrained, so that the fuel supply is stopped. Herein, the fuel level outside the enclosing member 60 is substantially the same as the height position of the opening for ventilation 67 of the enclosing member 60, which is higher than that in the case in which the enclosing member 60 is not provided (see FIG. 9) that is, the low-limit height of the fuel level for closing the air inlet 48. Accordingly, more fuel can be supplied into the fuel tank body 10. Thus, the tank volume can be increased without changing the outer shape of the tank body 10 in the second embodiment as well.

Herein, while the passing adjusting device is constituted by the through hole 66 in the present embodiment, the structure of the passing adjusting device should not be limited to this. For example, a valve to restrict the passing of the fuel only in a direction from the outside to the inside of the enclosing member 60 may be applied.

The other structures and effects of the second embodiment are substantially the same as those of the first embodiment, and the members of the second embodiment which have the same functions as those of the first embodiment are denoted by the same reference numerals in FIGS. 6 and 7.

### Embodiment 3

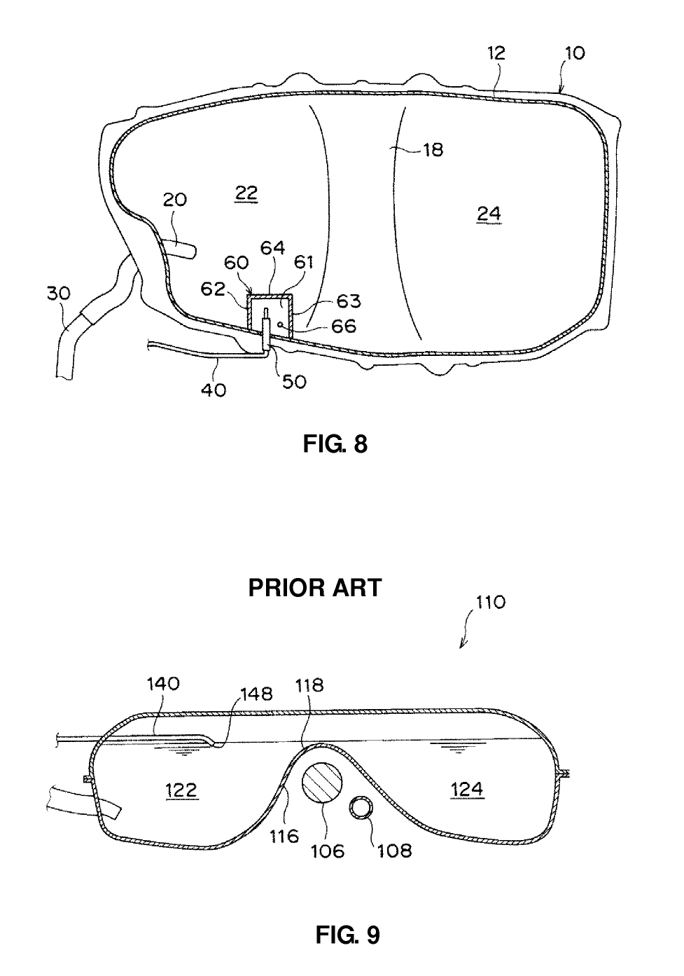

A fuel tank structure of a vehicle according to a third embodiment will be described referring to FIG. 8.

While the similar enclosing member 60 to the second embodiment is applied in the third embodiment, the air inlet 48 of the breather pipe 40 and the enclosing member 60 are arranged in the main tank portion 22 according to the third embodiment, which is only a difference from the second embodiment.

Specifically, the air inlet 48 of the breather pipe 40 is positioned near the breather-pipe insertion portion 50, so that the length of the part of the pipe 40 which extends in the inside space of the tank body 10 can be shortened as much as possible.

Since the rise in the fuel level inside the enclosing member 60 during the fuel supply is delayed in the third embodiment as well as the second embodiment, the tank volume can be increased without changing the outer shape of the tank body 10.

The other structures and effects of the third embodiment are substantially the same as those of the second embodiment, and the members of the third embodiment which have the same functions as those of the second embodiment are denoted by the same reference numerals in FIG. 8.

The present invention should not be limited to the above-described embodiments. For example, while the above-described embodiments show the structure of the so-called saddle type of fuel tank, the present invention is applicable to the non-saddle type of fuel tank.

What is claimed is:

1. A fuel tank structure of a vehicle, comprising:
a fuel tank body installed at the vehicle;
a fuel supply pipe supplying fuel into the fuel tank body;
a breather pipe connecting an inside and an outside of the fuel tank body, an air inlet of the breather pipe being arranged in an inside space of the fuel tank body; and
a fuel-level rise delaying device provided inside the fuel tank body to delay a rise in a level of the fuel supplied via the fuel supply pipe in a specified range around the air inlet of the breather pipe from a fuel-level rise in the other range.

2. The fuel tank structure of a vehicle of claim 1, wherein said fuel tank body has an upwardly-concaved portion extending in a vehicle longitudinal direction at a lower face thereof, the fuel tank body comprises a main tank portion and a sub tank portion which are separated from each other by said upwardly-concaved portion of the fuel tank body, said fuel supply pipe is connected to an inside space of said main tank portion, said air inlet of the breather pipe is arranged in an inside space of the sub tank portion, and said fuel-level rise delaying device comprises a partitioning member which is arranged to stand at the upwardly-concaved portion of the fuel tank body and partition the inside space of the sub tank portion from the inside space of said main tank portion, an upper end of the partitioning member standing at the upwardly-concaved portion being located at a specified height position which is higher than the air inlet of the breather pipe.

3. The fuel tank structure of a vehicle of claim 2, wherein said breather pipe is provided to extend from the outside of the fuel tank body to the inside of the fuel tank body, passing through a breather-pipe insertion portion formed at a wall portion of said main tank portion, and the breather pipe comprises a tank-outside pipe portion which is positioned outside the fuel tank body so as to extend outside from the breather-pipe insertion portion of the fuel tank and a tank-inside pipe portion which is positioned inside the fuel tank body so as to extend from the breather-pipe insertion portion to said air inlet.

4. The fuel tank structure of a vehicle of claim 1, wherein said fuel-level rise delaying device comprises an enclosing member which has an opening for ventilation at a specified height position which is higher than said air inlet of the breather pipe and encloses the air inlet of the breather pipe at least from below and side.

5. The fuel tank structure of a vehicle of claim 4, wherein said enclosing member has a passing adjusting device at a lower end portion thereof, the passing adjusting device allowing the fuel to flow out from an inside space to an outside space of the enclosing member, restricting the fuel flowing into the inside space from the outside space of the enclosing member.

6. The fuel tank structure of a vehicle of claim 5, wherein said passing adjusting device comprises a through hole which is formed at the lower end portion of the enclosing member.

7. The fuel tank structure of a vehicle of claim 4, wherein said fuel tank body has an upwardly-concaved portion extending in a vehicle longitudinal direction at a lower face thereof, the fuel tank body comprises a main tank portion and a sub tank portion which are separated from each other by said upwardly-concaved portion of the fuel tank body, said fuel supply pipe is connected to an inside space of said main tank portion, and said air inlet of the breather pipe and said enclosing member are arranged in an inside space of the sub tank portion.

8. The fuel tank structure of a vehicle of claim 5, wherein said fuel tank body has an upwardly-concaved portion extending in a vehicle longitudinal direction at a lower face thereof, the fuel tank body comprises a main tank portion and a sub tank portion which are separated from each other by said upwardly-concaved portion of the fuel tank body, said fuel supply pipe is connected to an inside space of said main tank portion, and said air inlet of the breather pipe and said enclosing member are arranged in an inside space of the sub tank portion.

9. The fuel tank structure of a vehicle of claim 6, wherein said fuel tank body has an upwardly-concaved portion extending in a vehicle longitudinal direction at a lower face thereof, the fuel tank body comprises a main tank portion and a sub tank portion which are separated from each other by said upwardly-concaved portion of the fuel tank body, said fuel supply pipe is connected to an inside space of said main tank portion, and said air inlet of the breather pipe and said enclosing member are arranged in an inside space of the sub tank portion.

10. The fuel tank structure of a vehicle of claim 4, wherein said fuel tank body has an upwardly-concaved portion extending in a vehicle longitudinal direction at a lower face thereof, the fuel tank body comprises a main tank portion and a sub tank portion which are separated from each other by said upwardly-concaved portion of the fuel tank body, said fuel supply pipe is connected to an inside space of said main tank portion, and said air inlet of the breather pipe and said enclosing member are arranged in an inside space of the main tank portion.

11. The fuel tank structure of a vehicle of claim 5, wherein said fuel tank body has an upwardly-concaved portion extending in a vehicle longitudinal direction at a lower face thereof, the fuel tank body comprises a main tank portion and a sub tank portion which are separated from each other by said upwardly-concaved portion of the fuel tank body, said fuel supply pipe is connected to an inside space of said main tank portion, and said air inlet of the breather pipe and said enclosing member are arranged in an inside space of the main tank portion.

12. The fuel tank structure of a vehicle of claim 6, wherein said fuel tank body has an upwardly-concaved portion extending in a vehicle longitudinal direction at a lower face thereof, the fuel tank body comprises a main tank portion and a sub tank portion which are separated from each other by said upwardly-concaved portion of the fuel tank body, said fuel supply pipe is connected to an inside space of said main tank portion, and said air inlet of the breather pipe and said enclosing member are arranged in an inside space of the main tank portion.
